(19) United States
(12) Patent Application Publication
(10) Pub. No.: US 2004/0125293 A1
(43) Pub. Date: Jul. 1, 2004

(54) Integrated color filter and fabricating method thereof

(76) Inventors: Jia-Shyong Cheng, Hsinchu Hsien (TW); Yu-Fang Wang, Taoyuan Hsien (TW)

Correspondence Address: RABIN & BERDO, P.C., Suite 500, 1101 14th Street, N.W., Washington, DC, 20005, US

(21) Appl. No.: 10/660,491

(22) Filed: Sep. 12, 2003

(30) Foreign Application Priority Data
Oct. 14, 2002 (TW) 91123565

(51) Int. Cl. G02F 1/1333

(52) U.S. Cl. 349/122; 349/43

(57) ABSTRACT

An integrated color filter and fabricating method thereof, featuring a transparent organic layer formed under or above a color filter, before or after the fabrication process of the color filter. The transparent organic layer has higher transparency and lower dielectric constant than the color filter. By combining the transparent organic layer and the color filter, the parasitic capacitance is reduced without sacrificing light transmission.

### BACKGROUND OF THE INVENTION

1. Field of the Invention

The present invention relates to a liquid crystal display with color filter on array substrate, and more particularly to an integrated color filter whereby the aperture ratio is increased and parasitic capacitance is lowered.

2. Description of the Related Art

FIG. 1 is a cross-section showing a conventional LCD. A liquid crystal layer 1 is placed between an active matrix substrate 10 and a color filter substrate 10′. In the manufacturing process thereof, a color filter layer, having red (R) 33, green (G) 34 and blue (B) 35 filter-units, and an active matrix 20 are respectively formed on glass substrates 10′ and 10. Next, the two substrates are aligned and joined with a gap therebetween, and liquid crystal is filled into the gap to form the liquid crystal layer 1. During manufacture, precise alignment must be maintained, and a specific gap must be preserved, otherwise yield rate is compromised.

To avoid the need for strict quality requirements, certain techniques involving an integrated color filter (ICF) have been developed, such as the color filter on array (COA) process and the array on color filter (AOC) process, these processes form the color filter, black matrix, and active matrix on the same substrate, and thus avoid the requirements for strict alignment.

FIG. 2 is a cross-section showing a COA-type LCD. An active matrix 20 manufacturing process is performed first on a glass substrate 10 to form thin film transistors 23. A color filter with red(R) 33, green(G) 34 and blue(B) 35 filter units is then formed directly on the active matrix substrate. By integrating the color filter and active matrix manufacturing process, possible light leakage resulting from misalignment is avoided, and aperture ratio and brightness are increased.

In the COA-type LCD, the color filter, having leveling ability, is disposed between the active matrix 20 and the liquid crystal layer 1, and the requirement of a black matrix in a conventional LCD is thus omitted, increasing the percentage of drivable liquid crystal and thereby raising the aperture ratio. To increase the aperture ratio of the LCD, the larger the pixel electrode 32 provided the better, and the pixel electrode 32 may overlap the signal lines thereunder (not shown). Because the pixel electrode 32 and the signal lines are both made of metallic materials, the insertion of an insulating color filter may cause parasitic capacitance, resulting in cross-talk or current leakage.

In the current COA-type LCD manufacturing process, the thickness of color filter is usually increased to about 3-5 μm to reduce parasitic capacitance. Although the parasitic capacitance can be thereby reduced, the light transmission of the color filter is also reduced, and therefore the aperture ratio and brightness are decreased.

For the above mentioned reasons, an important object is to reduce parasitic capacitance without sacrificing light transmission and brightness to achieve the best productive mode.

### SUMMARY OF THE INVENTION

Accordingly, an object of the invention is to provide an integrated color filter and manufacturing method thereof, featuring a transparent organic layer disposed under or above the color filter, before or after the fabrication of the color filter in a COA-type LCD manufacturing process. The transparent organic layer is made of a material having higher transparency and lower dielectric constant than the color filter. The combination of the transparent organic layer and the color filter is more effective in reducing the parasitic capacitance with less decrease in brightness due to the higher transparency and lower dielectric constant of the transparent organic layer. Thus, lower parasitic capacitance is achieved in a thinner combination layer of the color filter and transparent organic layer, without sacrificing light transmission.

Therefore, the present invention provides a liquid crystal display with an integrated color filter, an integrated color filter and the fabricating method thereof. The liquid crystal display with an integrated color filter comprises an active matrix substrate with a plurality of switching elements, an insulating layer formed on the active matrix substrate, a double-organic layer formed on the insulating layer, a plurality of pixel electrodes formed on the double-organic layer, electrically connected to the respective switching elements via a plurality of respective contact holes, a substrate positioned a predetermined distance above the active matrix substrate, and a liquid crystal layer between the two substrates.

The double-organic layer of the liquid crystal display may comprise a plurality of color-filter units and a transparent organic layer. The color-filter units layer can be formed above the transparent organic layer, or the transparent organic layer can be formed above the color-filter units layer.

The present invention further provides an integrated color filter, which comprises a substrate, a plurality of switching elements formed on the substrate, an insulating layer formed on the switching elements, a transparent organic layer formed above the insulating layer, a plurality of color-filter units formed above the transparent organic layer, and, a plurality of pixel electrodes formed above the color-filter units, and electrically connected to the respective switching elements via a plurality of respective contact holes, wherein the contact holes pass through the transparent organic layer, color-filter units and the insulating layer.

The present invention further provides an integrated color filter, which comprises a substrate, a plurality of switching elements formed on the substrate, an insulating layer formed on the switching elements, a plurality of color-filter units formed above the insulating layer, a transparent organic layer formed above the color-filter units, and a plurality of pixel electrodes formed above the color-filter units, and electrically connected to the respective switching elements via a plurality of respective contact holes, wherein the contact holes pass through the transparent organic layer, color-filter units and the insulating layer.

The invention provides a fabrication method of the integrated color filter, which comprises providing a substrate, forming a plurality of switching elements on the substrate, forming an insulating layer on the switching elements, forming a transparent organic layer on the switching elements, wherein the transparent organic layer has a first hole exposing a part of the surface of the insulating layer, etching the insulating layer by using the transparent organic layer as an etching mask to form a second hole in the insulating layer, wherein the second hole joins the first hole and exposes a part of the surface of the switching elements, forming a plurality of color-filter units with a third hole on the transparent organic layer, wherein the third hole forms a contact hole together with the first and the second holes to expose the part of the surface of the switching elements, and forming a plurality of pixel electrodes on the color-filter units, wherein the pixel electrodes are electrically connected with the switching elements via the contact hole.

The invention also provides a fabrication method of the integrated color filter, which comprises providing a substrate, forming a plurality of switching elements on the substrate, forming an insulating layer on the switching elements, forming a plurality of color-filter units with a first hole on the insulating layer, forming a transparent organic layer on the color-filter units, having a second hole to expose the first hole, etching the insulating layer by using the transparent organic layer as a mask, forming a third hole in the insulating layer to expose a part of the surface of the switching elements, wherein the third hole forms a contact hole together with the first and the second holes, and forming a plurality of pixel electrodes on the transparent organic layer, wherein the pixel electrodes are electrically connected with the switching elements via the contact hole.

According to the invention, although an additional transparent organic layer is formed under or above the color filter, the manufacturing process of the LCD can be completed without additional masks.

According to the invention, the transparent organic layer is preferably made of a material with light transmission above 90%, for example, polycarbonate, acrylic-resin, or a combination thereof. The dielectric constant of the transparent organic layer is preferably 2.6-3.6, and the thickness of the transparent organic layer is preferably 1.5-3.5 μm.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a cross-section showing a conventional LCD;

FIG. 2 is a cross-section showing a COA-type LCD;

FIGS. 3A-3E show the manufacturing process of the color filter in the first embodiment; and

FIGS. 4A-4E show the manufacturing process of the color filter in the second embodiment.

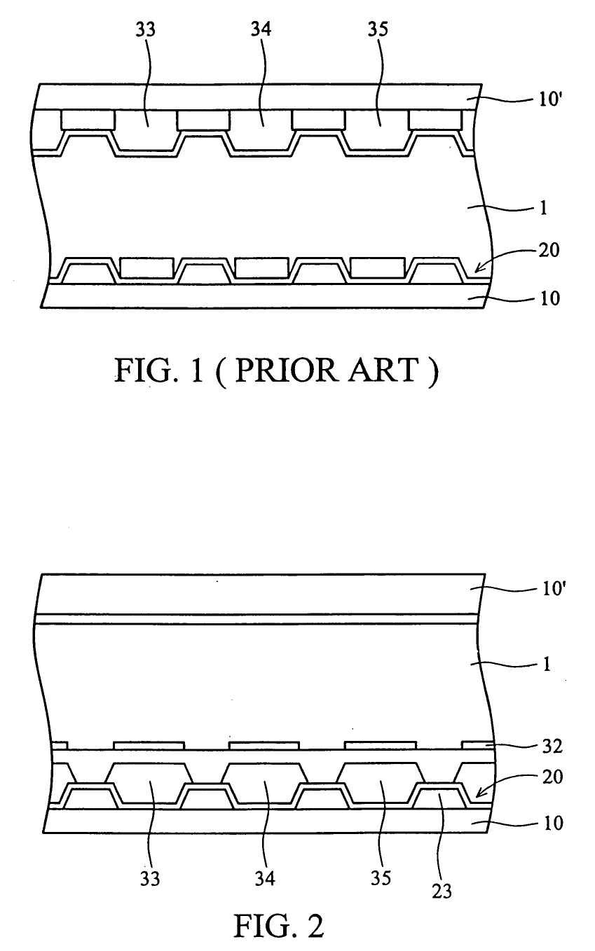

### DETAILED DESCRIPTION OF THE INVENTION

### FIRST EMBODIMENT

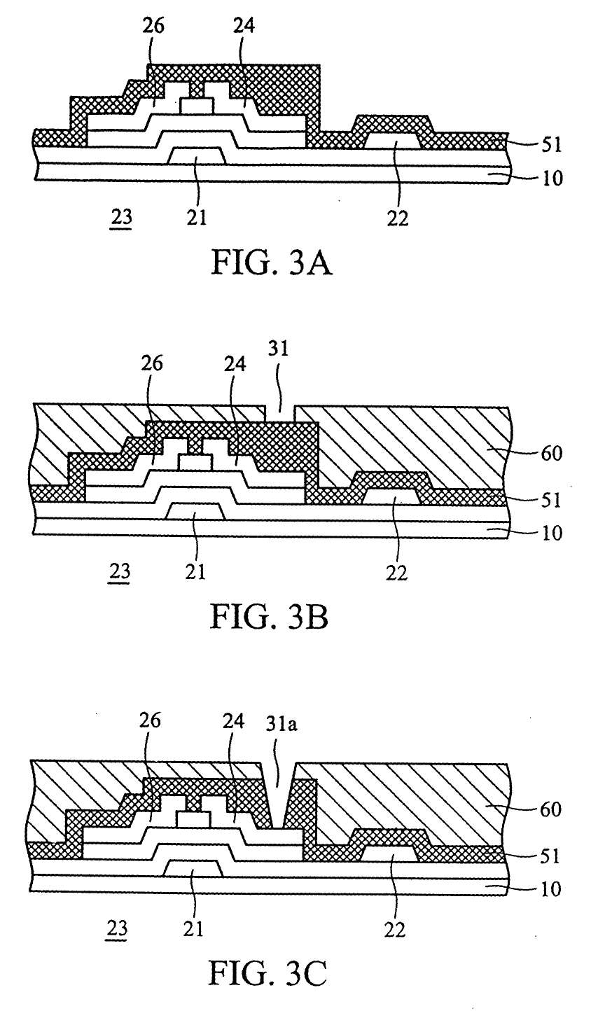

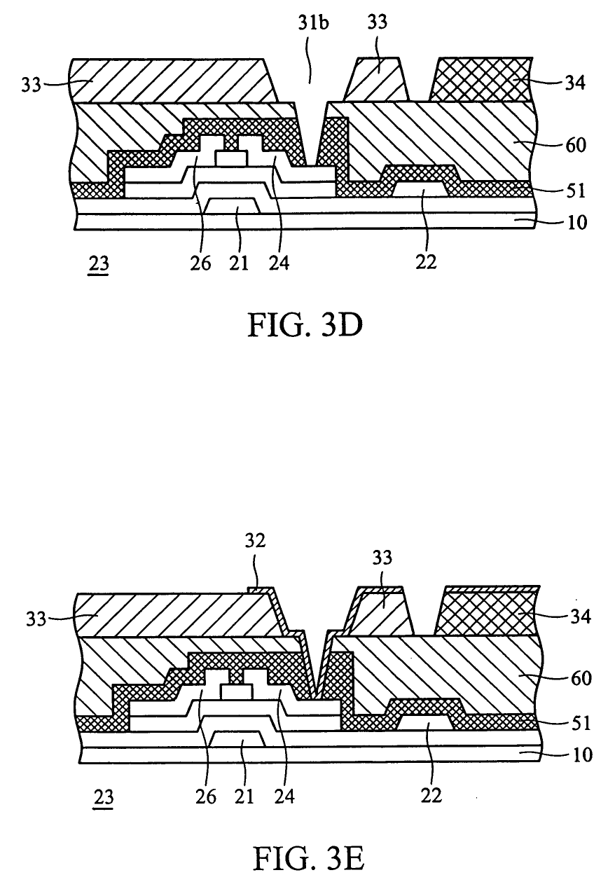

FIGS. 3A-3E schematically show the manufacturing process of color filter in the first embodiment.

In FIG. 3A, a substrate 10, for example, a glass substrate, is provided followed by an active matrix manufacturing process. The active matrix formed on the substrate 10 comprises a plurality of substantially parallel gate lines (not shown) in a row direction, a plurality of substantially parallel signal lines 22 in a column direction, and a plurality of switching elements 23, for example, thin film transistors, wherein the gate lines 21 and signal lines 22 are perpendicular to each other, and a plurality of pixel areas are enclosed by the adjacent gate lines 21 and adjacent signal lines 22, respectively. Next, an insulating layer 51 of, for example, silicon nitride is formed on the substrate 10.

In FIG. 3B, a transparent organic layer 60 is then formed on the glass substrate 10 by, preferably, spin-coating a transparent organic composite. The transparent organic layer 60 is preferably made of polycarbonate, acrylic resin or a combination thereof, having a dielectric constant around 3.0, with a thickness of 2.0 μm. Next, a hole 31 is defined in the transparent organic layer 60 by photolithography, corresponding to a predetermined position of a pixel electrode.

In FIG. 3C, by using the transparent organic layer 60 as an mask, the insulating layer 51 is etched to form a hole 31a exposing a part of the surface of the drain electrode 24. The insulating layer 51 of silicon nitride is through-hole etched by, for example, dry etching. This step is one of the inventive features, in which the transparent organic layer 60 is applied as the mask during the through-hole etching of the insulating layer 51. Compared to conventional processes, although an additional photolithography step is required to form the transparent organic layer 60, the application of the transparent organic layer 60 as the mask eliminates the need for a mask in the through-hole etching of the insulating layer 51. Thus the total number of masks required is the same.

In FIG. 3D, color-filter units of red 33, blue 34 and green (not shown) are sequentially formed on a predetermined part of the transparent organic layer 60. The color-filter units have a hole 31b corresponding to the hole 31a in the insulating layer 51, wherein the hole 31b forms a contact hole together with the hole 31 and the hole 31a, exposing a part of the drain electrode 24. The light transmission of the color-filter units is about 40%, the color gamma is about 66%, the dielectric constant is about 3.8, and the thickness is of 1 μm. The effective light transmission of the combined layer of transparent organic layer 60 and color-filter units is about 55%.

In FIG. 3E, a pixel electrode 32 is formed on the color-filter units by, for example, sputtering an indium tin oxide layer. The pixel electrode 32 electrically connects the drain electrode 24 via the contact hole.

### SECOND EMBODIMENT

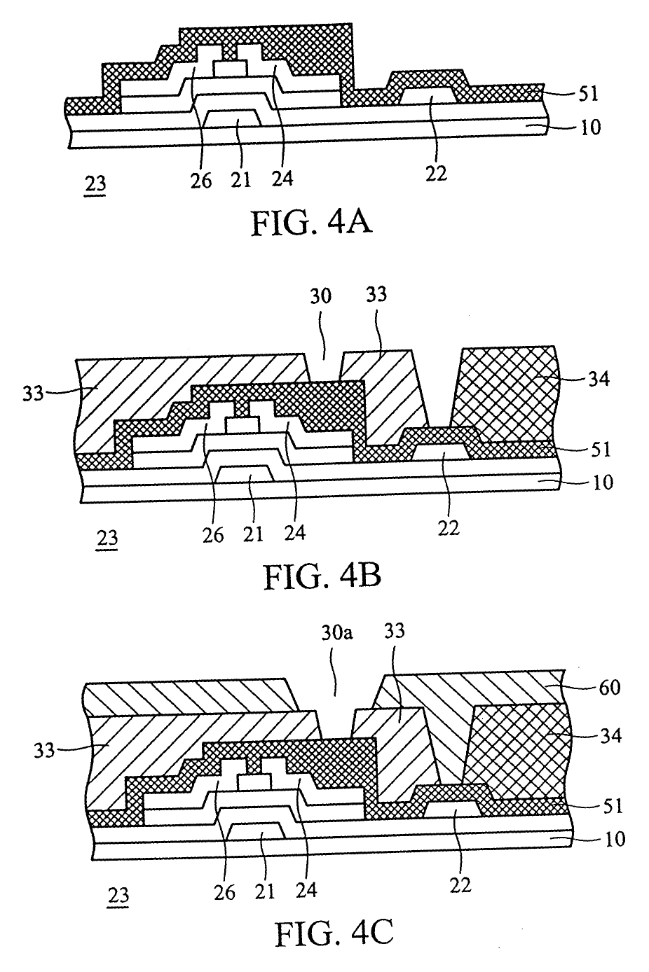

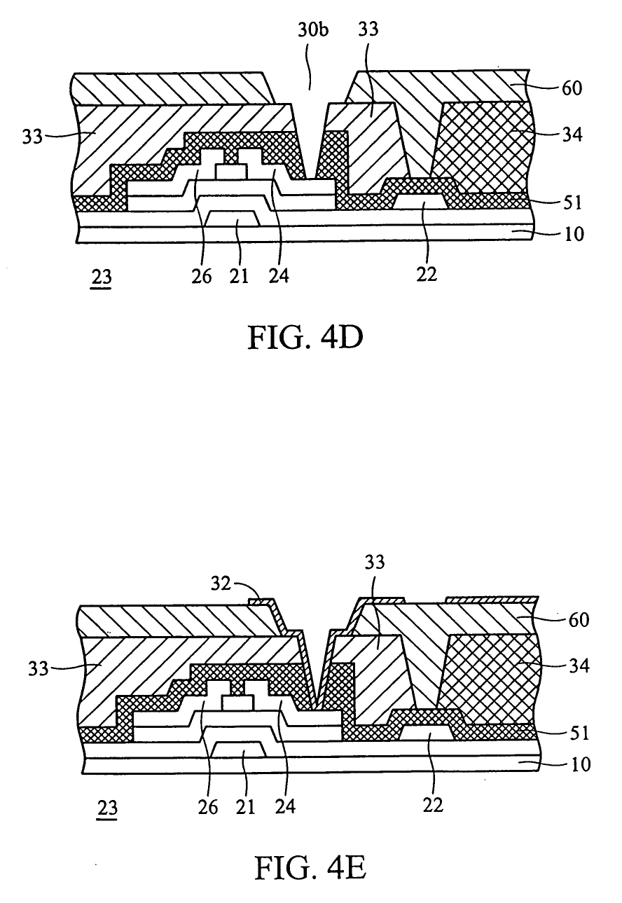

FIGS. 4A-4E show the manufacturing process of the color filter in the second embodiment.

In FIG. 4A, a substrate 10, for example, a glass substrate, is provided followed by an active matrix manufacturing process. The active matrix formed on the substrate 10 comprises a plurality of substantially parallel gate lines (not shown) in a row direction, a plurality of substantially parallel signal lines 22 in a column direction, and a plurality of switching elements 23, for example, thin film transistors, wherein the gate lines 21 and signal lines 22 are perpendicular to each other, and a plurality of pixel areas are enclosed by the adjacent gate lines 21 and adjacent signal lines 22, respectively. Next, an insulating layer 51 of, for example, silicon nitride is formed on the substrate 10.

In FIG. 4B, color-filter units of red 33, blue 34 and green (not shown) are sequentially formed on a predetermined part of the glass substrate 10. The color-filter units have a hole 30. The light transmission of the color-filter units is about 40%, the color gamma is about 66%, the dielectric constant is about 3.8, and a thickness of 1 μm.

In FIG. 4C, a transparent organic layer 60 is then formed on the glass substrate 10 by, preferably, spin-coating a transparent organic composite. The transparent organic layer 60 is preferably made of polycarbonate, acrylic resin or a combination thereof, having a dielectric constant around 3.0, with a thickness of 2.0 μm. Next, the transparent organic layer 60 and a part of the color-filter units are defined to form a hole 30a, exposing the hole 30. For example, the transparent organic layer 60 and the color-filter unit 33 above the drain electrode 24 are defined by photolithography to form a hole 30a to expose a part of the surface of the insulating layer 51. The effective light transmission of the combined layer of transparent organic layer 60 and color-filter units is about 55%.

In FIG. 4D, by using the transparent organic layer 60 as an mask, the insulating layer 51 is etched to form a hole 30b exposing a part of the surface of the drain electrode 24. The insulating layer 51 of silicon nitride is through-hole etched by, for example, dry etching. The hole 30b forms a contact hole together with the holes 30a and 30. This step is one of the inventive features, in which the transparent organic layer 60 is applied as the mask during the through-hole etching of the insulating layer 51. Compared to conventional processes, although an additional photolithography step is required to form the transparent organic layer 60, the application of the transparent organic layer 60 as the mask reduces a mask in the through-hole etching of the insulating layer 51. Thus the total number of masks required is the same.

In FIG. 4E, a pixel electrode 32 is formed on the color-filter units by, for example, sputtering an indium tin oxide layer. The pixel electrode 32 electrically connects the drain electrode 24 via the contact hole.

According to the above embodiments, the parasitic capacitance of the LCD is effectively reduced without sacrificing light transmission. Thus, by disposing a transparent organic layer under or above the color filter before or after the fabrication of the color filter in a COA-type LCD manufacturing process, as long as the transparent organic layer is made of a material having higher transparency and lower dielectric constant than the color filter The combination of the transparent organic layer and the color filter is more effective in reducing parasitic capacitance with less decrease in brightness due to the higher transparency and lower dielectric constant of the transparent organic layer. Therefore, lower parasitic capacitance is achieved in a thinner combination layer of the color filter and transparent organic layer, without the sacrifice of light transmission. Furthermore, though an additional transparent organic layer is formed under or above the color filter, the manufacturing process of the LCD can be completed without requiring additional masks.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A liquid crystal display with an integrated color filter, comprising:
an active matrix substrate with a plurality of switching elements;
an insulating layer formed on the active matrix substrate;
a double-organic layer formed on the insulating layer;
a plurality of pixel electrodes formed on the double-organic layer, and electrically connected to the respective switching elements via a plurality of respective contact holes;
a substrate positioned a predetermined distance above the active matrix substrate; and
a liquid crystal layer between the two substrates.

2. The liquid crystal display with an integrated color filter as claimed in claim 1, wherein the double-organic layer comprises a plurality of color-filter units and a transparent organic layer.

3. The liquid crystal display with an integrated color filter as claimed in claim 2, wherein the color-filter units layer is formed above the transparent organic layer.

4. The liquid crystal display with an integrated color filter as claimed in claim 2, wherein the transparent organic layer is formed above the color-filter units layer.

5. The liquid crystal display with an integrated color filter as claimed in claim 2, wherein the transparent organic layer is formed of polycarbonate or acrylic-resin.

6. The liquid crystal display with an integrated color filter as claimed in claim 2, wherein the light transmission of the transparent organic layer is above 90%.

7. The liquid crystal display with an integrated color filter as claimed in claim 2, wherein the dielectric constant of the transparent organic layer is 2.6-3.6.

8. The liquid crystal display with an integrated color filter as claimed in claim 2, wherein the thickness of the transparent organic layer is 1.5-3.5 μm.

9. The liquid crystal display with an integrated color filter as claimed in claim 2, wherein the dielectric constant of the color-filter units is 3.5-5.0.

10. The liquid crystal display with an integrated color filter as claimed in claim 2, wherein the thickness of the color-filter units is 1.0-2.0 μm.

11. The liquid crystal display with an integrated color filter as claimed in claim 2, wherein the color-filter units includes red, green and blue units.

12. The liquid crystal display with an integrated color filter as claimed in claim 1, wherein the pixel electrodes are made of indium tin oxide.

13. The liquid crystal display with an integrated color filter as claimed in claim 1, wherein the contact holes pass through the insulating layer and the double-organic layer.

14. An integrated color filter, comprising:
a substrate;
a plurality of switching elements formed on the substrate in a matrix arrangement;
an insulating layer formed on the switching elements;
a transparent organic layer formed above the insulating layer;
a plurality of color-filter units formed above the transparent organic layer; and
a plurality of pixel electrodes formed above the color-filter units, and electrically connected to the respective switching elements via a plurality of respective contact holes, wherein the contact holes pass through the transparent organic layer, color-filter units and the insulating layer.

15. An integrated color filter, comprising:
a substrate;
a plurality of switching elements formed on the substrate in a matrix arrangement;
an insulating layer formed on the switching elements;
a plurality of color-filter units formed above the insulating layer;
a transparent organic layer formed above the color-filter units; and
a plurality of pixel electrodes formed above the color-filter units, and electrically connected to the respective switching elements via a plurality of respective contact holes, wherein the contact holes pass through the transparent organic layer, color-filter units and the insulating layer.

16. A method of fabricating an integrated color filter, comprising:
providing a substrate;
forming a plurality of switching elements on the substrate in a matrix arrangement;
forming an insulating layer on the switching elements;
forming a transparent organic layer on the switching elements, wherein the transparent organic layer has a first hole exposing a part of the surface of the insulating layer;
etching the insulating layer by using the transparent organic layer as an etching mask to form a second hole in the insulating layer, wherein the second hole joins the first hole and exposes a part of the surface of the switching elements;
forming a plurality of color-filter units with a third hole on the transparent organic layer, wherein the third hole forms a contact hole together with the first and the second holes to expose the part of the surface of the switching elements; and
forming a plurality of pixel electrodes on the color-filter units, wherein the pixel electrodes are electrically connected with the switching elements via the contact hole.

17. The method of fabricating an integrated color filter as claimed in claim 16, wherein the transparent organic layer is made of polycarbonate or acrylic-resin.

18. The method of fabricating an integrated color filter as claimed in claim 16, wherein the light transmission of the transparent organic layer is above 90%.

19. The method of fabricating an integrated color filter as claimed in claim 16, wherein the dielectric constant of the transparent organic layer is 2.6-3.6.

20. The method of fabricating an integrated color filter as claimed in claim 16, wherein the thickness of the transparent organic layer is 1.5-3.5 μm.

21. The method of fabricating an integrated color filter as claimed in claim 16, wherein the dielectric constant of the color-filter units is 3.5-5.0.

22. The method of fabricating an integrated color filter as claimed in claim 16, wherein the thickness of the color-filter units is 1.0-2.0 μm.

23. The method of fabricating an integrated color filter as claimed in claim 16, wherein the color-filter units includes red, green and blue units.

24. The method of fabricating an integrated color filter as claimed in claim 16, wherein the pixel electrodes are made of indium tin oxide.

25. A method of fabricating an integrated color filter, comprising:
providing a substrate;
forming a plurality of switching elements on the substrate in a matrix arrangement;
forming an insulating layer on the switching elements;
forming a plurality of color-filter units with a first hole on the insulating layer;
forming a transparent organic layer on the color-filter units, having a second hole to expose the first hole;
etching the insulating layer by using the transparent organic layer as a mask, forming a third hole in the insulating layer to expose a part of the surface of the switching elements, wherein the third hole forms a contact hole together with the first and the second holes; and
forming a plurality of pixel electrodes on the transparent organic layer, wherein the pixel electrodes are electrically connected with the switching elements via the contact hole.

26. The method of fabricating an integrated color filter as claimed in claim 25, wherein the transparent organic layer is made of polycarbonate or acrylic-resin.

27. The method of fabricating an integrated color filter as claimed in claim 25, wherein the light transmission of the transparent organic layer is above 90%.

28. The method of fabricating an integrated color filter as claimed in claim 25, wherein the dielectric constant of the transparent organic layer is 2.6-3.6.

29. The method of fabricating an integrated color filter as claimed in claim 25, wherein the thickness of the transparent organic layer is 1.5-3.5 μm.

30. The method of fabricating an integrated color filter as claimed in claim 25, wherein the dielectric constant of the color-filter units is 3.5-5.0.

31. The method of fabricating an integrated color filter as claimed in claim 25, wherein the thickness of the color-filter units is 1.0-2.0 μm.

32. The method of fabricating an integrated color filter as claimed in claim 25, wherein the color-filter units includes red, green and blue units.

33. The method of fabricating an integrated color filter as claimed in claim 25, wherein the pixel electrodes are made of indium tin oxide.
